(19) United States
(12) Patent Application Publication
(10) Pub. No.: US 2009/0171787 A1
(43) Pub. Date: Jul. 2, 2009

(54) Impressionative Multimedia Advertising

(75) Inventors: Tao Mei, Beijing (CN); Xian-Sheng Hua, Beijing (CN); Shipeng Li, Beijing (CN)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/143,696

(22) Filed: Jun. 20, 2008

Related U.S. Application Data
(60) Provisional application No. 61/018,357, filed on Dec. 31, 2007.

(51) Int. Cl. G06Q 30/00

(52) U.S. Cl. 705/14

(57) ABSTRACT

A method for making online adverisement makes an impressionative presentation of an advertisement to a viewer. The impressionative presentation is an impressionized version of an original online source medium such as a photo. The method associates advertisements with the source medium based, at least in part, on calculated ad relevance, and determines one or more viewer iteractive points on the original source medium. The method then presents to the viewer an ad-augmented medium including an impressionized version of the source medium, which has the ability to change the form of impression to a viewer in response to an interactive act conducted by the viewer. The ad-augmented medium may include the associated advertisement content or direct the viewer's attention thereto.

### RELATED APPLICATIONS

This application claims priority to U.S. Provisional Patent Application No. 61/018,357, filed on Dec. 31, 2007, entitled “IMPRESSIONATIVE MULTIMEDIA ADVERTISING”, and hereby incorporated by reference.

### BACKGROUND

Online advertising has become the primary source of revenue for the majority of media and publishing sites. According to one source, the online advertising market is projected to grow to $80 billion by 2010. In this context, Internet advertising companies such as DoubleClick, Right Media, and aQuantive have become acquisition targets worth multibillion dollars. What is behind of these deals is that online advertising has truly become the key and essential strategy in Web 2.0 era for competing and thriving in today's emerging business world.

Online advertising has evolved rapidly, with some changes quite fundamental, to achieve better results. Contextual advertising, for example, is among the early successful methods used in online advertising and still is an important way to make online advertising more effective. Contextual advertising displays graphical or text-only ads that correspond to the keywords of a search or to the content of the webpage on which the ad is shown. These ads are believed to have a greater chance to attract a viewer, because they tend to share a similar context as the user's search query. Conventional contextual advertising embeds ads at fixed positions on webpages. Different from conventional contextual advertising, inline advertising aims to deliver ads inside the content by embedding keyword hyperlinks or ad-carrying media in the content itself such as an article, and image, or a video. The ads sponsored by an advertiser. When a user follows a link, it leads to a website or another medium sponsored by the advertiser.

The primary goal of any advertisement is to get viewer attention. It is desirable to develop new and better online advertising methods to increase user attention and improve the advertising effect.

### SUMMARY

Disclosed in this document is a method for making multimedia advertisements. The method makes an impressionative presentation of an advertisement to a user using an impressionized version of an original online source medium such as a photo. The method associates advertisements with the source medium based, at least in part, on calculated ad relevance, and determines one or more user interactive points on the original source medium. The method then presents to the viewer an ad-augmented medium including an impressionized version of the source medium. The impressionized version of the source medium has the ability to change the form of impression to a viewer in response to an interactive act conducted by the viewer. The ad-augmented medium may include the associated advertisement content or is able to direct the user's attention thereto. In one embodiment, the impressionized version of the source medium is created by combining, at least in part, the source medium and the associated advertisement content or an ad-relevant content related to the associated advertisements.

The impressionized version of the source medium can be designed to be interactive and impressionative in various forms, such as an ad magic, an ad trick, an ad lead, an ad fusion, and an ad discovery, as described herein. A viewer interactive point may be the entire source medium, a region or a point contained therein. A viewer interactive point may also be an object identified in the medium (e.g., a person in a photo). The viewer interactive act by which a viewer interacts with the advertisement can be a pointer-over motion or a pointer click.

This summary is provided to introduce the subject matter of image advertising systems, which are further described below in the Detailed Description. This summary is not intended to identify essential features of the claimed subject matter, nor is it intended for use in determining the scope of the claimed subject matter.

### BRIEF DESCRIPTION OF THE FIGURES

The detailed description is described with reference to the accompanying figures. In the figures, the left-most digit(s) of a reference number identifies the figure in which the reference number first appears. The use of the same reference numbers in different figures indicates similar or identical items.

FIG. 1 is a simplified block diagram illustrating an exemplary framework of impressionative advertising.

FIG. 2 is a flowchart of an exemplary process used in impressionative advertising.

FIGS. 3-8 illustrate a series of exemplary impressionized media and corresponding user scenarios for impressionative advertising.

FIG. 9 illustrates an illustrative architecture that may employ the described impressionative advertising.

### DETAILED DESCRIPTION

### An Overview

The techniques disclosed in this document are a novel extension of the rapid online advertisement evolution underway in terms of objectives, strategies, and solutions. In light of the present disclosure, the trends of online advertising may be summarized into three generations, including the existing technologies and new technologies disclosed herein.

The first generation is conventional contextual advertising, including contextual media advertising, which displays graphical or text-only ads that correspond to the keywords of a search or to the content of the page on which the ad is shown. Conventional contextual advertising embeds ads at fixed positions on webpages.

The second generation is inline advertising which aims to deliver ads inside the content (as opposed to placing the ads aside the content as in the first generation advertising) by embedding keyword hyperlinks or media-based ads in a medium such as an article, an image or video. When a user follows a link, it leads to a website or ad-carrying medium sponsored by the advertiser.

This disclosure describes a next generation online advertising which may be referred to as “impressionative advertising” when the content carrier is a media such as an image, an animation, or a video. Given successful Web 2.0 applications on the Internet, Impressionative advertising described herein is believed to potentially make a large impact on the online advertisement.

Impressionative advertising described herein is an extension of inline advertising methods disclosed in U.S. patent application Ser. No. 11/626,251, filed on Jan. 23, 2007, entitled “Automatically Inserting Advertisements into Source Video Content Playback Streams”; U.S. patent application Ser. No. 11/767,410, filed on Jun. 22, 2007, entitled “Image Advertising System”; U.S. patent application Ser. No. 11/858,628, filed on Sep. 20, 2007, entitled “Advertisement Insertion Points Detection for Online Video Advertising”; and U.S. patent application Ser. No. 11/855,872, filed on Sep. 14, 2007, entitled “Multi-Modal Relevancy Matching”. The inline advertising described in these patent applications aims at a more effective way for media advertising by embedding ads within rather than aside the media content. For example, by content analysis, a set of appropriate ad insertion points or regions can be detected within video/audio streams (temporal positions) or on images (spatial positions). Relevant ads are inserted at the ad insertion points or regions.

One aim of impressionative advertising to make online advertising more impressive, “game-ized” and thus more attractive and more engaging to the users, as more and more user interaction and mashup of online media is getting involved. To this end, impressionative advertising leverages techniques in computer vision and graphics, as well as computer human interaction. Compared with conventional inline advertising, the strength of impressionative advertising is viewer participation, not merely ad publishing. Such distinctive features of impressionative advertising can help in an online advertising company gain advantage in the next generation of online adverting business by leveraging mashup technologies, user-generated content, and user participation.

### Framework of Impressionative Advertising

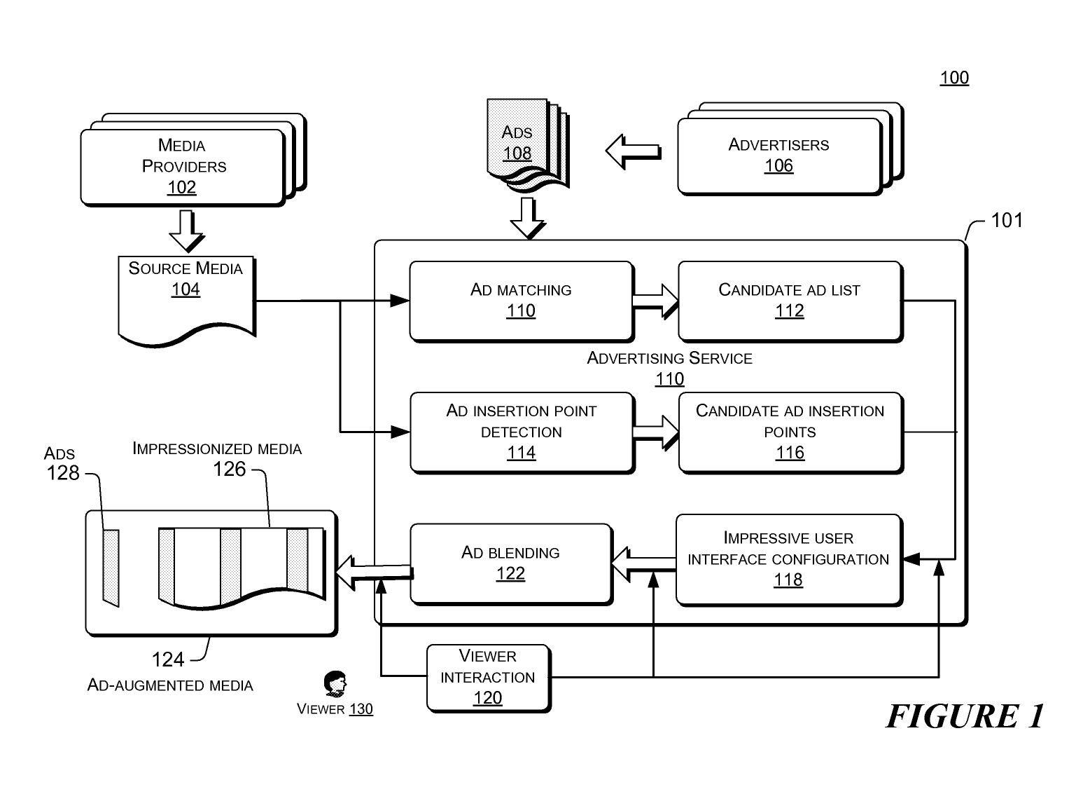

FIG. 1 is a simplified block diagram illustrating an exemplary framework of impressionative advertising. The impressionative advertising framework 100 is illustrated in the context of a general process that summarizes the distinction of each generation of online advertising, with each generation built upon a previous one. It is noted, however, the presently disclosed impressionative advertising does not have to include all steps or all components of the previous generation online advertising, such as contextual advertising and inline advertising.

The impressionative advertising framework 100 enables content providers 102 to provide source media 104. The content providers 102 may include anyone who owns source media, and is willing to disseminate such content to the general public. For example, the content providers 102 may include professional as well as amateur artists such as photographers, or anyone who has taken pictures and is willing to share on the Internet. The source media 104 are generally machine-readable works containing images, movies, video clips, homemade videos, animations, etc.

Advertisers 106 may produce advertisements (ads) 108, which are generally one or more images intended to generate viewer interest in particular goods, services, or points of view. In some instances, an advertisement 108 may be one or more are still images such as photos. In other instances, an advertisement 108 may be a video clip. In the exemplary framework 100, the source media 104 and the advertisements 108 may be transferred to advertising service 101 via one or more networks such as the Internet. The one or more networks may include wide-area networks (WANs), local area networks (LANs), or other network architectures.

The advertising service 101 is generally configured to integrate the source media 104 with the advertisements 108 to generate ad-augmented media 124, which is presented to a viewer 130 to be viewed. The ad-augmented media 124 may each include an impressionized medium 126. Each impressionized medium 126 is a modified version (impressionized version) of a corresponding source medium 104, and has added features to impress or attract the attention of a viewer. As will be described in the examples illustrated herein, in one embodiment, impressionized medium 126 is adapted to cause a change of an impression to a viewer in response to an interactive act conducted by the viewer in relation to the impressionized medium 126. The change of the impression may either be in the impressionized medium 126 or at a position near the impressionized medium 126.

Specifically, given an online source media 104 which may be an image, a collection of images (such as search results), a video sequence, or even an audio clip, the advertising service 101 may use ad matching module 110 to match the source media 104 with advertisements 108. The ad matching produces a list of candidate ads 112 selected from the inventory of advertisements 108 and ranked according to the relevance between input source media 104 and advertisements 108. Such relevance can be derived from textual information such as keywords, titles, surrounding text, and transcripts, and also can be based on multimodal similarity, such as perception level similarity (e.g., dominant color and camera or object motion in video content; tempo and beat in audio content) and semantic level (e.g., object category and visual concept). An example of methods for computing relevance based our multimodal similarity is disclosed in U.S. patent application Ser. No. 11/855,872, filed on Sep. 14, 2007, entitled “Multi-Modal Relevancy Matching”. Furthermore, in principle, any techniques used in image classification, including those used in image search technologies, may be adapted for computing a relevance used for matching an image source media and an advertisement.

A candidate ad list generated in this manner using pattern matching techniques would provide a sufficient basis for simple contextual advertising. However, the impressionative advertising described herein may go further from here. At the next level, ad insertion point detection module 114 automatically detects a set of candidate ad insertion points using multimedia content analysis and computer vision technologies. The ad insertion point detection generates candidate ad insertion points 116. The ad insertion point detection 114 and the ad matching 110 may be performed either in serial or in parallel and be complementary to each other, but may also be performed as an integrated process. Each of the two processes may also be performed alone without the other or performed in substitution of each other.

The ad insertion points could be a traditional spot on the timeline of a source video/audio, or spatial positions, regions or objects in a source image, or even some positions on the web page containing (or displaying) the source media 104. The detection of ad insertion points can be based on different combinations of two measurements content discontinuity and attractiveness such as that disclosed in U.S. patent application Ser. No. 11/626,251, filed on Jan. 23, 2007, entitled “Automatically Inserting Advertisements into Source Video Content Playback Streams”; U.S. patent application Ser. No. 11/767,410, filed on Jun. 22, 2007, entitled “Image Advertising System”; and U.S. patent application Ser. No. 11/858,628, filed on Sep. 20, 2007, entitled “Advertisement Insertion Points Detection for Online Video Advertising”.

Given a list of candidate ad insertion points 116 and relevant ads 112, there is a basis for making inline advertising. However, impressionative advertising as disclosed herein may further obtain impressive features and user interface using impressive user interface configuration module 118. The impressive features and user interface are designed to leverage user interaction and assist the delivery of impressionative advertising. Impressive features and user interface are based on modifications of the source media 104 and designed to impress or attract the attention of a viewer. User interaction could be simple mouse clicking or mouse-over motion, or a game-like action such as finding the ads hidden within impressionized media presented to the viewer, and so on. Examples of impressive features and user interaction will be described in a later section in this document.

The configuration of impressive features and user interface using impressive user interface configuration module 118 may or may not take user input through viewer interaction 120. If no user input is used at this stage, the impressive user interface features and user interface may be selected and configured in a predetermined manner.

Finally, an ad blending module 122 generates ad-augmented media 124, which in one embodiment each include an impressionized medium 126. In one embodiment, impressionized medium 126 is generated by combining, at least in part, the corresponding source medium 104 and at least one advertisement in the candidate advertisement list 112. The inclusion of the advertisement may be either direct (by including the actual content of the advertisement being the impressionized medium 126) or indirect (by including an ad-relevant content related to the advertisement). Additionally, the ad-augmented medium 124 may also include an ad 128, which can be an advertisement in the candidate ad list 112, besides the impressionized medium 126. When presented to the viewer 130, the ad 128 may be displayed along with the impressionized medium 126.

It is noted that in this document, “combining” two media (specifically the source medium and an advertisement) to generate an impressionized medium may or may not involve true digital blending at a pixel level. Although in some embodiments, blending at a pixel level may be performed using techniques such as image cloning, in other embodiments the combining may be a simple insertion of one medium (or a block or a segment thereof) into the other medium. Still in some other embodiment, the combining may not involve mixing one medium within the other medium at all. For example, the impressionized medium (or an impressionized version of the source medium) can be generated by placing the ad(s) around or near the source medium, e.g., at certain positions within the corresponding webpage. Such a combination can be used, for example, as a background of the skin of the medium player installed on the viewer's computer to display the media, or a trajectory moving on the webpage.

Ad blending 122 may or may not take user input through viewer interaction 120, depending on the configuration of impressionative advertising. For example, in one embodiment, ad blending 122 takes place after the viewer 130 has selected a particular feature on the impressive user interface (such as by clicking on a viewer interactive point). In another embodiment, ad blending 122 is performed before user input. In this case, only the presentation of impressionized media 126 is user interactive by taking user input through viewer interaction 120.

In one embodiment, ad blending engine 122 does not blend the source media 104 and the associated candidate advertisement(s) 112, but instead blends the source media 104 with an ad-relevant content related to the associated advertisement(s) 112. For example, for an advertisement of winter clothing, an example of an ad-relevant content is a winter scene (e.g., snow). In this case, the advertisement 112 may be displayed along with the impressionized media 126 at a position, for example, outside of the impressionized media 126 but close thereto.

As will be illustrated in the example is described herein, the impressionized media 126 can vary according to viewer behavior. In this manner, impressionative advertising can be more viewer-engaging (e.g., like a game) and more impressive than conventional advertising such as contextual and inline advertising.

As illustrated above with reference to FIG. 1, conventional contextual advertising only focuses on ad relevance matching, accomplished by ad matching module 110 and candidate ad list 112. Inline advertising considers an additional matter of ad insertion point detection, accomplished by ad insertion point detection module 114 and candidate ad insertion points 116. In comparison, in addition to addressing existing issues in the previous two generations of online advertising, impressionative advertising further leverages user interaction and ad blending to make advertising more game-ized and more impressive.

It is appreciated that impressionative advertising can be built upon contextual advertising only without performing inline advertising. Specifically, impressive user interface configuration 118 and ad blending 122 may be implemented right after ad matching 110 has generated candidate ad list 112 without detecting ad insertion points. In this simplified embodiment, ad blending 122 may be either done globally over the entire source media 104 without localization, or locally blended at random positions in the source media 104. The ad blending 122 may also simply place the advertisement 112 beside the source media 104.

Impressionative advertising described herein is an attempt to leverage the advantages of both the Web environment and multimedia presentations. To be exact, the method aims at using incentive interactions and/or “game-ized” ads companying impressionized media to attract viewer's attentions. In other words, impressionative advertising makes ads themselves attractive. The technique can be based on contextual ads, in which contextually relevant ads and source media are integrated. In one embodiment, impressionative advertising described herein automates the process of creating impressionized media, and minimizes the efforts of advertisers and source media providers to generate impressionative ads.

### Exemplary Embodiments of the Impressionative Advertising Method

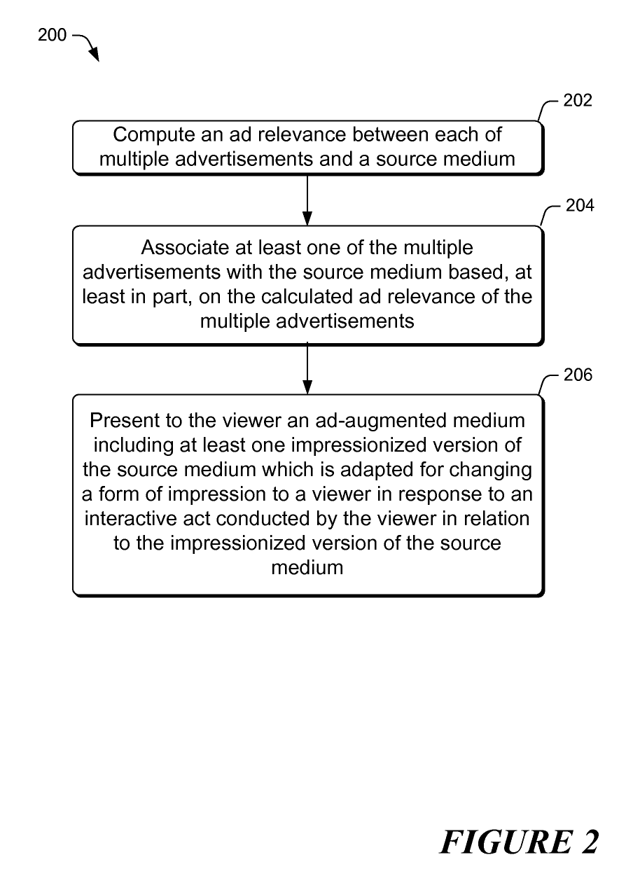

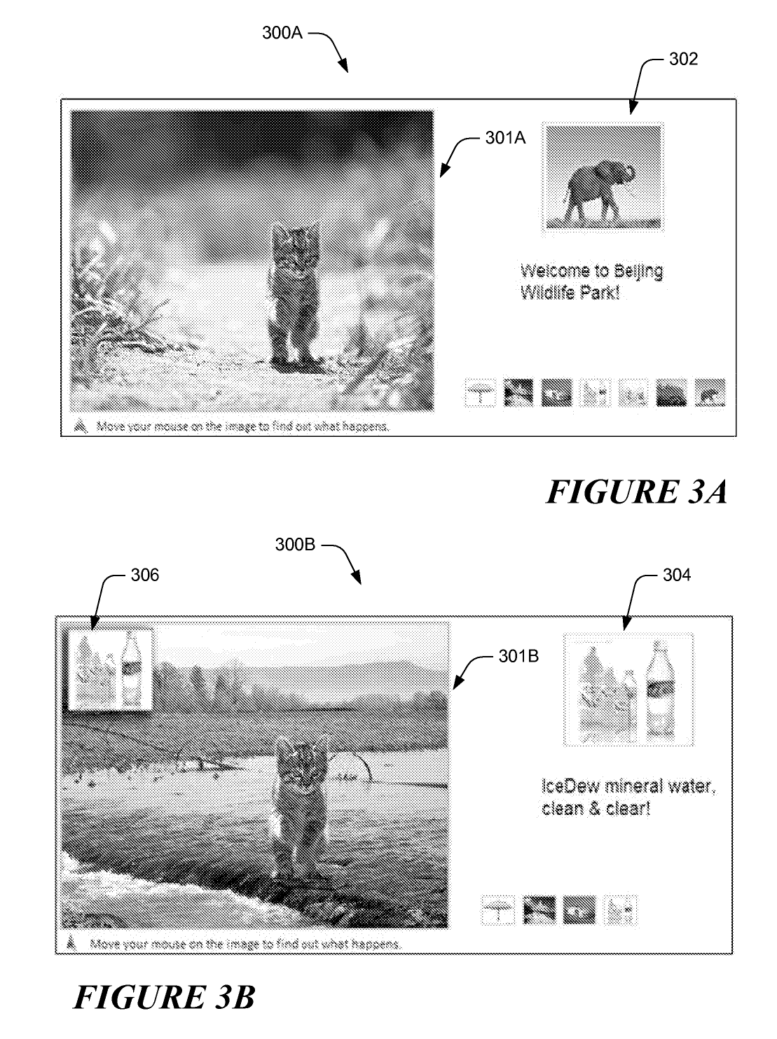

FIG. 2 is a flowchart of an exemplary process used in the impressionative advertising method. The process is based on the framework 100 of FIG. 1, and is illustrated in further details with exemplary types of impressionized media with reference to FIGS. 3-8. In this description, the order in which a process is described is not intended to be construed as a limitation, and any number of the described process blocks may be combined in any order to implement the method, or an alternate method.

At block 202, an ad matching module (110) computes an ad relevance between each of multiple advertisements (108) and a source medium (104). This results in a candidate ad list 112.

At block 204, the ad matching module (110) associates at least one of the multiple advertisements in the candidate ad list (112) with the source medium (104). The association is based, at least in part, on the calculated ad relevance of the multiple advertisements.

At block 206, the advertising engine presents to the viewer (130) an ad-augmented medium (124) including, at least in part, the associated advertisement (128) and an impressionized version (126) of the source medium. The impressionized medium (126) is adapted to cause a change of an impression to a viewer in response to an interactive act conducted by the viewer in relation to the impressionized version of the source medium.

Alternatively, at block 206, an impressionized medium is presented in response to a viewer conducting an interactive act at a viewer interactive point in or in relation to the source medium. The impressionized medium in this embodiment may or may not have the ability to further change its impression to the viewer.

As will be illustrated with examples in FIGS. 3-8, the impressionized medium may be generated by combining, at least in part, the source medium and the associated advertisement(s) or an ad-relevant content related to the associated advertisement(s). In the ad-augmented medium presented to the viewer, the associated advertisement(s) can be displayed along with the impressionized medium. The impressionized version of the source medium may include a viewer interactive point through which the viewer conducts an interactive act. The viewer interactive point can be a single point or a region in the medium. The viewer interactive point can also be the entire medium. Where the medium comprises an image, the viewer interactive point may be an object identified in the image. The interactive act conducted by the viewer may be a pointer-over motion or a pointer click (such as that by a mouse or a touch-sensitive pen). Multiple impressionized media can be presented in alternation. In embodiments where the advertisements are included in the impressionized media, it may be preferred that the advertisements appear in a non-salient region of the original media.

### Exemplary Impressionized Media

FIGS. 3-8 illustrate a series of exemplary impressionized media and corresponding user scenarios for impressionative advertising. These examples use a still image as the source medium for an illustrative purpose. It is noted that exemplary techniques for impressionative image advertising can be easily extended to video advertising and animated advertising.

FIGS. 3A and 3B illustrate a first type of impressionized media dubbed “ad magic”. FIG. 3A shows an ad-augmented medium 300A includes an impressionized image 301A and an advertisement 302 displayed along with the image 301A. In response to a viewer interaction, the ad-augmented medium 300A changes to an ad-augmented medium 300B shown in FIG. 3B which includes an impressionized image 301B and an advertisement 302 displayed along with the impressionized image 301B.

Specifically, the impressionized image 301A shows a foreground object (a cat) with a background. As a viewer clicks on or moves the mouse over the image 301A, the impressionized medium 301A changed its form of impression to another impressionized image 301B, which is an impressive variation of the impressionized image 301A. As shown, the background of the impressionized image 301A changes to a different one in the impressionized image 301B. Correspondingly, a new advertisement 304 replaces the previous advertisement 302. The product advertised in the new advertisement 304 may be related to the content of the new background in the impressionized image 301B, but such correlation is not required. In addition to displaying an advertisement 304 beside the impressionized image 301B, another advertisement 306 (either the same as the advertisement 304 or a different one) may be displayed within the impressionized image 301B.

The above described change from the ad-augmented image 300A to 300B may be a one-time change for each act of viewer interaction, or a continuous one once initiated by an act of viewer interaction. For example, when the viewer moves the mouse on an online image (e.g., the impressionized image 301A or an original source image supplied by a provider), the background of the image alternates randomly with background-relevant ads appearing beside or within the image. The ad window beside the image may guide the viewer to the corresponding advertisers. The varying of background may appear magic to the viewer, hence the dubbed name “ad magic” for this type of impressionized images accompanied by advertisements.

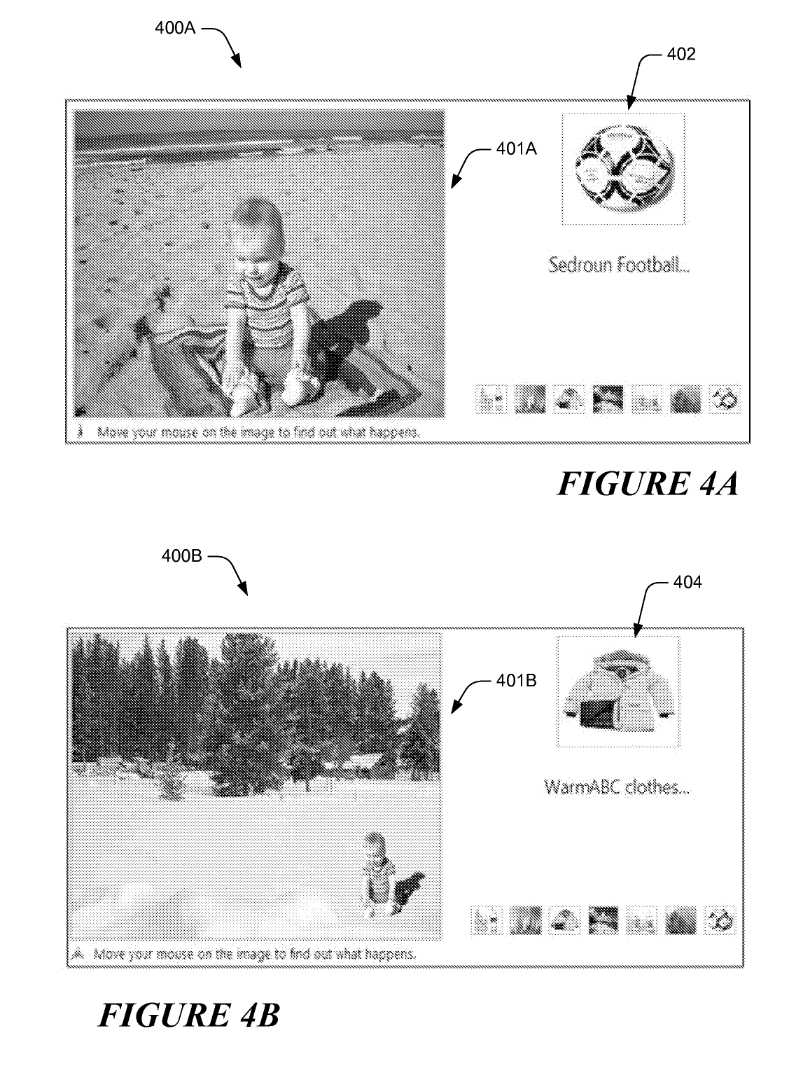

FIGS. 4A and 4B illustrate a second type of impressionized media dubbed “ad trick”. This is a variation of “ad magic” shown in FIGS. 2A and 2B. Similarly, FIG. 4A shows an ad-augmented medium 400A includes an impressionized image 401A and an advertisement 402 displayed along with the image 401A. In response to a viewer interaction, the ad-augmented medium 400A changes to an ad-augmented medium 400B shown in FIG. 4B which includes an impressionized image 401B and an advertisement 402 displayed along with the impressionized image 401B.

Specifically, the impressionized image 401A shows a foreground object (a child) with a background. As a viewer clicks on or moves the mouse over the image 401A, the impressionized image 401A changed its form of impression to another impressionized image 401B, which is an impressive variation of the image 401A. As shown, the background of the image 401A changes to a different one in the impressionized image 401B. Correspondingly, a new advertisement 404 replaces the previous advertisement 402. The product advertised in the advertisement 404 may be related to the content of the new background in the impressionized image 401B (e.g., winter clothing in advertisement 404 is conceptually related to the winter scene in the background of the impressionized image 401B), but such correlation is not required.

Different from “ad magic”, in the “ad trick” shown in FIGS. 4A and 4B the foreground object (the child) is resized or adapted to the background. In one embodiment, the background and the ads are randomly changed periodically, which may result in some fantastic background replacements, making the viewer curious of what the next background will be and where this child will appear in the background.

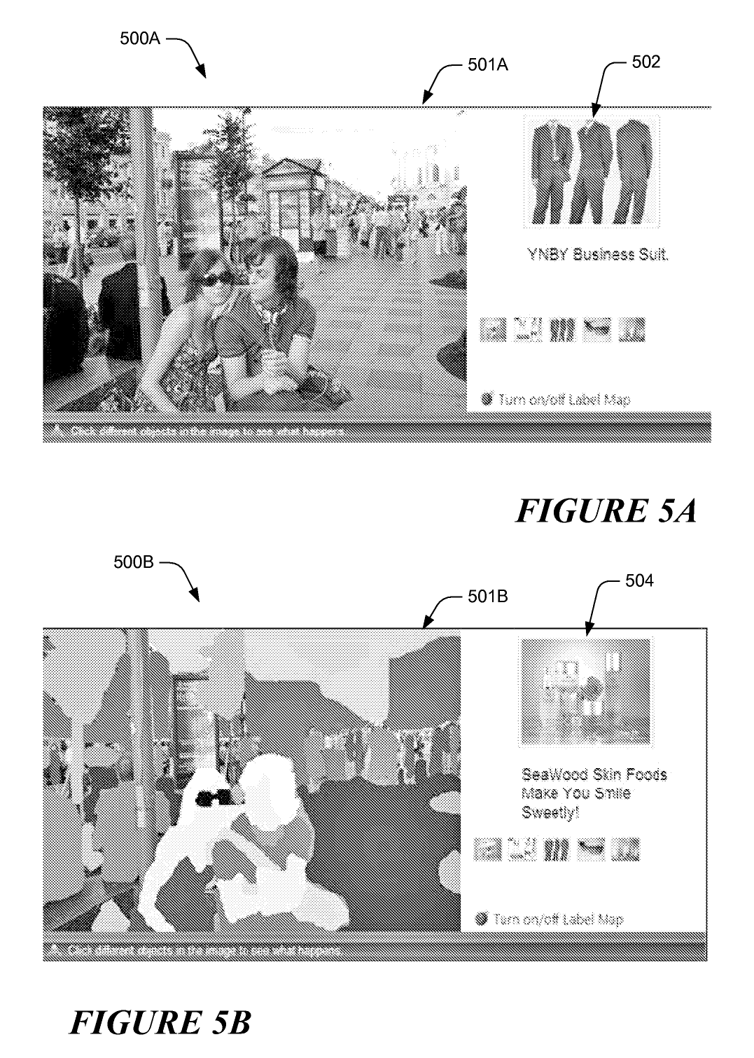

FIGS. 5A and 5B illustrate a third type of impressionized media dubbed “ad lead”. FIG. 5A shows an ad-augmented medium 500A includes an impressionized image 501A and an advertisement 502 displayed along with the image 501A. In response to a viewer interaction, the ad-augmented medium 500A changes to an ad-augmented medium 500B shown in FIG. 5B which includes an impressionized image 501B and an advertisement 502 displayed along with the impressionized image 501B.

The impressionized image 501A shows multiple objects such as a woman wearing sunglasses. As the viewer surfing a website site and finds something interesting or attractive in the impressionized image 501A, e.g., the sunglasses or clothes, the viewer may click on the interesting object, and finds relevant ads in ad window beside the image. In other words, an interesting object in the image leads the viewer to an advertisement, hence the dubbed name “ad lead”.

For example, as the viewer clicks on or moves the mouse over the sunglasses worn by the woman in the impressionized image 501A, the impressionized image 501A changed its form of impression to another impressionized image 501B, which is an variation of the impressionized image 501A. In the example shown in FIG. 5B, the rest of the image is sketched or roughed out to highlight the sunglasses (the object interested the viewer) in the impressionized image 501B. Correspondingly, a new advertisement 504 replaces the previous advertisement 502.

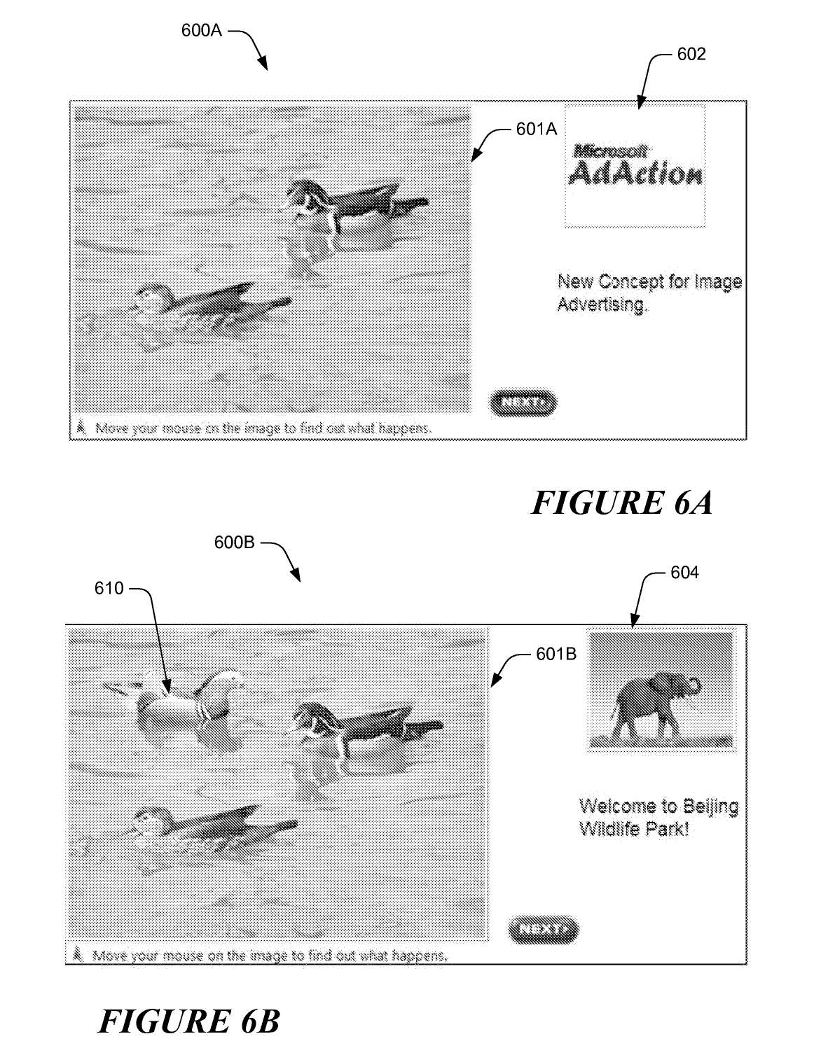

FIGS. 6A and 6B illustrate a fourth type of impressionized media dubbed “ad fusion”. FIG. 6A shows an ad-augmented medium 600A includes an impressionized image 601A and an advertisement 602 displayed along with the image 601A. In response to a viewer interaction, the ad-augmented medium 600A changes to an ad-augmented medium 600B shown in FIG. 6B which includes an impressionized image 601B and an advertisement 602 displayed along with the impressionized image 601B.

Specifically, as the viewer moves the mouse over the impressionized image 601A, it changes the impression to that of another impressionized image 601B. As shown, an advertisement or an advertisement related content (such as an advertisement related object) is seamlessly cloned, mixed, or mingled with the original image, or placed at an appropriate position within the image, to form the impressionized image 601B, which is a variation of the impressionized image 601A. In the example shown in FIG. 6B, the rest of the image remains substantially unchanged but an ad-related object (the additional bird 610 swimming on the water) is introduced in the impressionized image 601B. Correspondingly, a new advertisement 604 replaces the previous advertisement 602. In one embodiment a variety of ad-related objects periodically appear in the impressionized image within a short time. The ad-related objects (such as the additional bird 610) can be blended in the impressionized image 601B using image cloning techniques to ensure less-intrusiveness without substantially destroying the basic theme or subject of the image based on the source image. In this context, the image 601A can either be an impressionized image based on the source image or the source image itself.

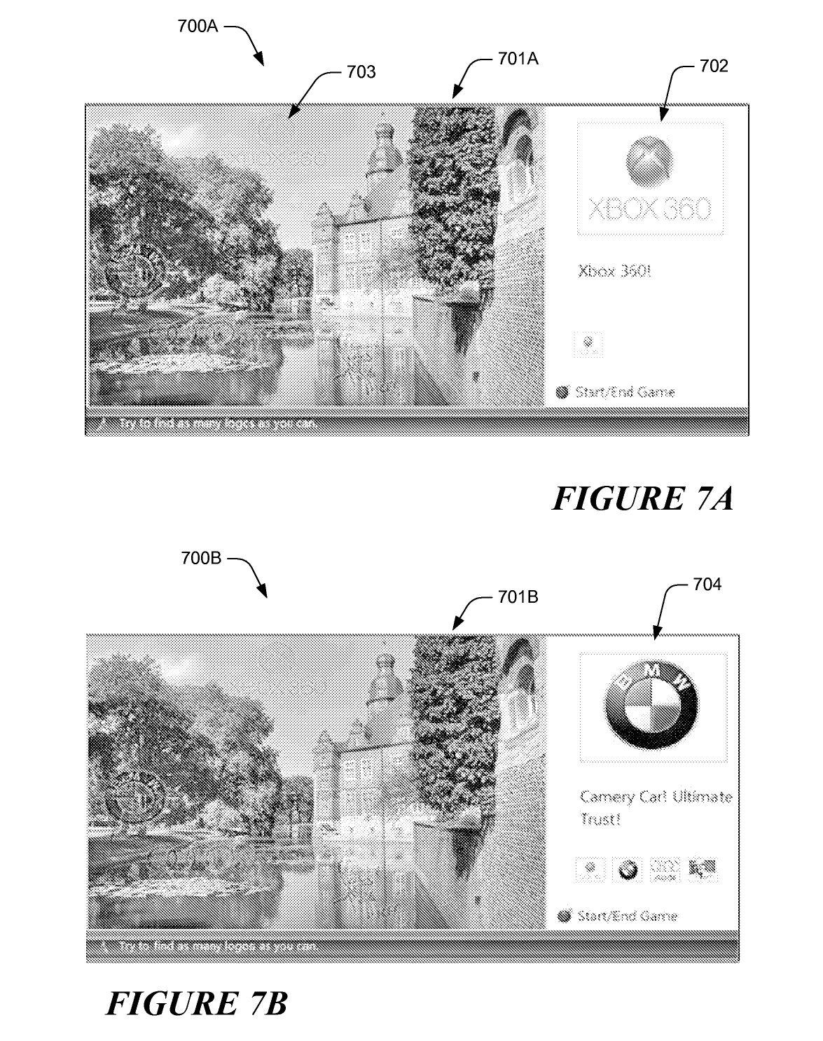

FIGS. 7A and 7B illustrate a fifth type of impressionized media dubbed “ad discovery”. This type of impressionative advertising incorporates a mini game designed for the viewer to find the ads in an online image. FIG. 7A shows an ad-augmented medium 700A includes an impressionized image 701A and an advertisement 702 displayed along with the image 701A. In response to a viewer interaction, the ad-augmented medium 700A changes to an ad-augmented medium 700B shown in FIG. 7B which includes an impressionized image 701B and an advertisement 702 displayed along with the impressionized image 701B.

The impressionized image 701A is an ad-embedded version of the original source image. Specifically, the impressionized image 701A embeds multiple advertisements each associated with a respective viewer interactive point. In the example shown in the impressionized image 701A, the multiple advertisements (e.g., the Xbox logo 703) are included in a nonobvious but discoverable manner. The ad-augmented image 700A may display an instruction to challenge the user to discover as many as advertisements hidden in the impressionized image 701A.

The advertisement 702 is displayed along with the impressionized image 701A. Upon discovery by the viewer another advertisement, the ad-augmented image 700A changed its form of impression to another ad-augmented image 700B including an impressionized image 701B. The new discovered advertisement 704 is displayed along with the impressionized image 701B. The impressionized image 701B may or may not be the same as the impressionized image 701A.

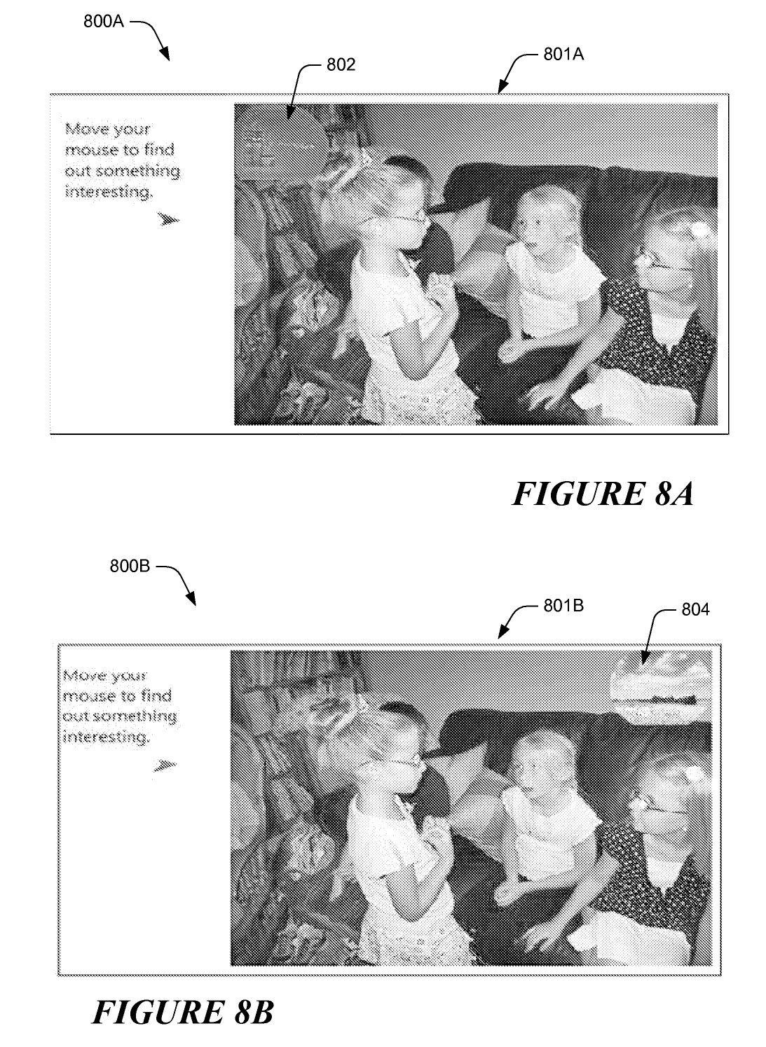

FIGS. 8A and 8B illustrate a sixth type of impressionized media dubbed “ad corner”. FIG. 8A shows an ad-augmented medium 800A includes an impressionized image 801A and an advertisement 802 displayed along with the image 801A. In response to a viewer interaction, the ad-augmented medium 800A changes to an ad-augmented medium 800B shown in FIG. 8B which includes an impressionized image 801B and an advertisement 802 displayed along with the impressionized image 801B.

The impressionized image 801A is an ad-embedded version of the original source image. Specifically, the impressionized image 801A embeds multiple advertisements each associated with a respective viewer interactive point within the image. As the viewer moves the mouse over the impressionized image 801A, an advertisement (or an advertisement related content, such as an advertisement related object) emerged from a position at or near the pointer of the mouse. For example, as the viewer clicks on or moves the mouse over a corner position in the image 801A, an advertisement 802 hidden at that corner is revealed. As the viewer clicks on or moves the mouse over another corner position, the impressionized image 801A changed its form of impression to another impressionized image 801B, in which an advertisement 804 is displayed. The advertisements are hidden at non-salient positions such as the corners of the image to make the advertising less intrusive.

Examples illustrated above involve viewer interactions to various degrees. Especially, “ad lead” and “ad discovery” may be designed like a game to have more viewer interactions. It is noted that the above example are only a small sample of potential applications of impressionative multimedia advertisement. These examples are used only to illustrate the concept of impressionative advertising. The concept may be extended to a variety of applications.

### Technologies Used in Impressionative Advertising

The impressionative online advertisement described herein may use a variety of technologies as its basic components. In addition to the technologies disclosed in the several patent applications cited herein (such as video segmentation, discontinuity and attractiveness detection, relevancy matching, and multimedia semantic analysis), the following is a list of other exemplary technologies that may be used.

Image segmentation: Using image segmentation technology, a source image or a video frame can be first segmented into a set of regions. The technique is then used to detect the candidate regions which are suitable to be replaced by ads. Mature techniques in computer vision for image segmentation are available for this purpose. Examples include graph cut disclosed in J. Shi, J. Malik, “Normalized Cuts and Image Segmentation”, IEEE Transactions on Pattern Analysis and Machine Intelligence, 22(8): 888-905, August 2000; and JSEG disclosed in Y. Deng, B. S. Manjunath, “Unsupervised Segmentation of Color-Texture Regions in Images and Vide”, IEEE Transactions on Pattern Analysis and Machine Intelligence, 23(8): 800-810, August 2001. Furthermore, image matting technique disclosed in A. Levin, D. Lischinski, Y. Weiss, “A Closed Form Solution to Natural Image Matting”, In Proceedings of IEEE Computer Vision and Pattern Recognition, pp. 61-68, 2006, can be used with user interaction to achieve better soft-segmentation.

Image cloning: Using image cloning technology, less-intrusiveness may be achieved. Less-intrusiveness is an important principle for online advertising. To this end, ads are preferred to be seamlessly embedded within media content. Impressionative advertising may use image cloning techniques such as that disclosed in P. Perez, M. Gangnet, A. Blake, “Poisson image editing”, ACM Transactions on Graph, 22(3): 313-318, 2003, or blending techniques, to seamlessly manipulate and edit either regions or objects within media content and ads.

Multimedia presentation and summarization: Impressionative advertising may embed ads seamlessly in not only conventional images and videos, but also unconventional multimedia presentations such as a video presentation approach named “Video Collage” described in T. Wang, T. Mei, X.-S. Hua, X. Liu, H.-Q. Zhou, “Video Collage: A Novel Presentation of Video Sequence”, In Proceedings of IEEE International Conference on Multimedia & Expo, pp. 1479-1482, July 2007; and X. Liu, T. Mei, X.-S. Hua, B. Yang, H.-Q. Zhou, “Video Collage”, In Proceedings of ACM International Conference on Multimedia, Augsburg, Germany, September 2007. In a video collage, a photo collection or video sequence can be presented by a synthesized static picture with compact and visually appealing effect. The technique may also leverage user interaction to make collage adapt to users' preferences.

User interface: Technologies in user interface (UI) and computer human interaction (CHI) may be used to make advertising more impressive and game-ized in other to attract viewer participation.

Media authoring: To leverage user-generated content and user interaction, impressionative advertising may automatically or semi-automatically create attractive ad videos or images based on media authoring techniques. This will encourage users to contribute more high-quality content and to involve in ad generation.

### Illustrative System Architecture

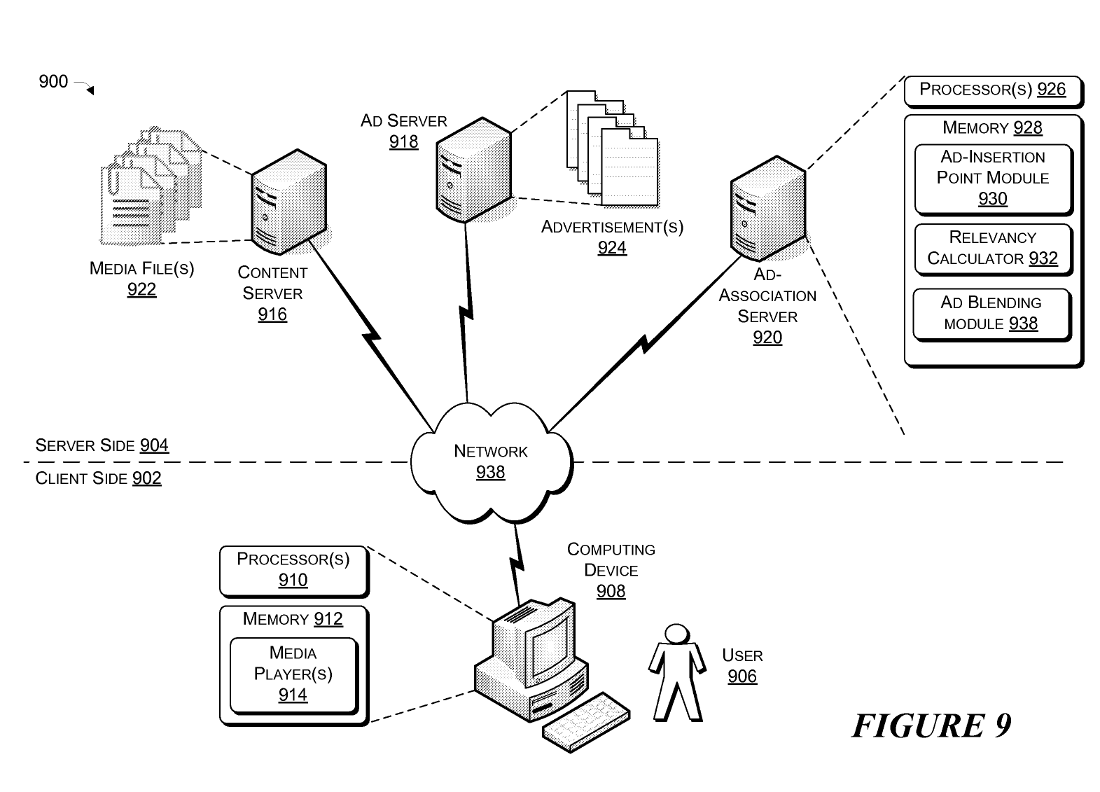

FIG. 9 illustrates an illustrative architecture 900 that may employ the described impressionative advertising. In illustrated architecture 900, some components reside on a client side 902 and other components reside on a server side 904. However, note that these components may reside in multiple other locations. For instance, all of the components of FIG. 9 may exist on client side 902 or on server side 904. Furthermore, two or more of the illustrated components may combine to form a single component at a single location.

Furthermore, illustrative architecture 900 of FIG. 9 should be understood in connection to the framework 100 illustrated in FIG. 1. For example, media files 922 and advertisements 924 in FIG. 9 may be the equivalents of source media 104 and advertisements 108 in FIG. 1, respectively.

As illustrated, however, client side 902 depicts a user 906 operating a computing device 908. Computing device 908 includes one or more processors 910, as well as memory 912 that includes a media player 914. User 906 may operate computing device 908 to download, stream, or otherwise consume a media file with use of media player 914. While FIG. 9 illustrates computing device 908 as a personal computer (PC), other implementations may employ, without limitation, a laptop computer, a mobile phone, a personal digital assistants (PDA), a portable media player (PMP) (e.g., a portable video player (PVP) and a digital audio player (DAP)), and/or the like.

Computing device 908 may connect, via a network 938, to server side 904 of architecture 900. Illustrated network 938 represents any one or combination of multiple different types of networks, such as cable networks, the Internet, and wireless networks. Server side 904, meanwhile, includes a content server 916, an advertisement server 918, and an advertisement-association server (ad-association server) 920. Content server 916 includes one or more media files 922, which may be delivered to one or more computing devices such as computing device 908 on client side 902.

Media files 922 generally comprise digital or analog content, such as videos, songs, movies, multimedia presentations, slide presentations, documents images, games, and/or any other type of content. In some cases, some or all of media files 922 comprise user-created and/or user-uploaded image or video files. Here, content server 916 may comprise a server of an image sharing website or a video sharing website. Whatever the form of media files 922, however, content server 916 may provide these media files to devices such as computing device 908 by downloading, progressive downloading, streaming, emailing, or the like.

Advertisement server 918, meanwhile, includes one or more advertisements 924. Advertisements 924 may include image advertisements, video advertisements, audio advertisements, textual advertisements, animated advertisements, and/or any type of advertisement capable of conveying a message to a consuming user such as user 906. In instances where some or all of media files 922 comprise image or video files, some or all of advertisements 924 may similarly comprise image or video advertisements.

Multiple different entities may provide some or all of advertisements 924 to advertisement server 918. For instance, advertising agents, product makers, service providers, companies, individuals, grass-roots users, or any other entity who wishes to spread or convey a message may so provide some or all of advertisements 924. In addition, while a single advertisement server is shown, other environments may employ multiple servers and/or may employ advertisements without servers.

Next, ad-association server 920 functions to determine an advertisement, such as one of advertisements 924, to associate with a media file, such as one of media files 922. Additionally, ad-association server 920 may associate an advertisement with a particular ad-insertion point of the media file.

An ad-insertion point represents a position (e.g., measured in a spatial dimension, measured in time, byte offset, etc.) of the media file with which an advertisement should be associated. An ad-insertion point may comprise a single pixel or an extended region in image (including the entire image). An ad-insertion point may also comprise a single instant in time (e.g., an ad is inserted in a file at a time of 0:15:00) or a segment of the file in a certain interval. In the example of an image media file and an image advertisement, for instance, the associated image advertisement may be presented at the determined ad-insertion point when a viewer, such as viewer 906, performs an interactive act on the image. In the example of a video media file and a video advertisement, for instance, the associated video advertisement may be played at the determined ad-insertion point when a viewer, such as viewer 906, plays the video.

As illustrated, ad-association server 920 includes one or more processors 926, as well as memory 928. Memory 928 here includes an ad-insertion point module 930, a relevancy calculator 932, and an and-blending module 936.

Ad-insertion point module 930 functions to determine one or more ad-insertion points within a media file. Module 930 may determine these points by actively establishing the points or by receiving an indication of the points by another entity. Given these one or more ad-insertion points, ad-association server 920 determines one or more advertisements to associate with each of the points based, at least in part, on relevancies of the advertisements.

Relevancy calculator 932, for instance, may comprise a global relevance comp letter that calculates a relevancy between a particular advertisement and most or all of the media file itself (i.e., a global relevancy). That is, calculator 932 determines how relevant the particular advertisement is to the media file generally. Calculator 932 may determine such relevancies with reference to multiple pieces of information about the particular advertisement and the media file.

Relevancy calculator 932 may also comprise a local relevancy calculator 934, which calculates a relevancy between the particular advertisement and one or more of the determined ad-insertion points in the media file (i.e., a local relevancy). That is, the local relevancy calculator determines how relevant the particular advertisement is to a particular ad-insertion point. Again, the local relevancy calculator may base this relevancy on multiple pieces of information discussed in detail below.

Finally, ad-blending module 936 blends one or more advertisements with one or more advertisements at the ad-insertion points based on the calculated global and/or local relevancies. Note that multiple (e.g., two or more) advertisements may be analyzed for each of multiple ad-insertion points that exist within a single media file. Conversely, a single advertisement and/or a single ad-insertion point may exist for other media files. In any event, when an advertisement is associated, the advertisement may be shown, played, inserted, consumed, or otherwise employed at or near the corresponding ad-insertion point.

As shown in the examples illustrated in FIGS. 3-8, the advertisements may be embedded in the media file. In other instances, an associated advertisement may be shown adjacent or near the media file as specified by the insertion point.

### Conclusion

Disclosed herein is a multimedia advertising platform that enables impressionative advertising. Unlike other existing online advertising services which only focus on publishing, impressionative advertising may take advantage of participation, impressiveness, and viewer incentives.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for making online advertisement, the method comprising:
computing an ad relevance between each of multiple advertisements and a source medium;
associating at least one of the multiple advertisements with the source medium based, at least in part, on the calculated ad relevance of the multiple advertisements; and
presenting to the viewer an ad-augmented medium including, at least in part, the at least one of the multiple advertisements and an impressionized version of the source medium, wherein the impressionized version of the source medium is adapted to cause a change of an impression to a viewer in response to an interactive act conducted by the viewer in relation to the impressionized version of the source medium.

2. The method as recited in claim 1, wherein the impressionized version of the source medium is generated by combining, at least in part, the source medium and the at least one of the multiple advertisements or an ad-relevant content related to the at least one of the multiple advertisements.

3. The method as recited in claim 1, wherein, in the ad-augmented medium presented to the viewer, the at least one of the multiple advertisements is displayed along with the at least one impressionized version of the source medium.

4. The method as recited in claim 1, wherein the impressionized version of the source medium includes a viewer interactive point through which the viewer conducts the interactive act.

5. The method as recited in claim 4, wherein the viewer interactive point is a region in the source medium.

6. The method as recited in claim 5, wherein the source medium comprises an image, and the viewer interactive point is an object identified in the image.

7. The method as recited in claim 1, wherein the interactive act conducted by the viewer comprises a pointer-over motion or a pointer click.

8. The method as recited in claim 1, wherein presenting to the viewer at least one impressionized version of the source medium comprising:
presenting multiple impressionized versions of the source medium in alternation.

9. The method as recited in claim 1, wherein the source medium includes an image having a foreground object and a background, and the at least one impressionized version of the source medium comprises a variation of the image having substantially the same foreground object and an alternative background.

10. The method as recited in claim 1, wherein the source medium includes an image having a foreground object and a background, and the at least one impressionized version of the source medium comprises a variation of the image having a resized version of the same foreground object and an alternative background.

11. The method as recited in claim 1, wherein the at least one viewer interactive point is a visually identifiable object in the source medium, and the at least one impressionized version of the source medium comprises a highlighted version of the visually identifiable object and an altered background.

12. The method as recited in claim 1, wherein the at least one impressionized version of the source medium comprises an ad-embedded version of the source medium which embeds the at least one of the multiple advertisements each associated with a respective viewer interactive point.

13. The method as recited in claim 12, wherein the ad-embedded version of the source medium hides the at least one of the multiple advertisements in nonobvious but discoverable manner, the method further comprising:
challenging the viewer to discover the at least one of multiple advertisements hidden in the ad-embedded version of the source medium.

14. The method as recited in claim 13, further comprising:
upon discovery by the viewer one of the multiple advertisements, displaying the discovered advertisement along with the at least one impressionized version of the source medium.

15. The method as recited in claim 1, wherein the at least one impressionized version of the source medium each embeds the at least one of the multiple advertisements each in association with a viewer interactive point, the method further comprising:
displaying one of the advertisements as the viewer moves a pointer over the respective viewer interactive point.

16. The method as recited in claim 1, wherein the at least one impressionized version of the source medium contains the at least one of the multiple advertisements in a non-salient region.

17. A method for making online advertisement, the method comprising:
computing an ad relevance between each of multiple advertisements and a source medium;
associating at least one of the multiple advertisements with the source medium based, at least in part, on the calculated ad relevance of the multiple advertisements; and
in response to a viewer conducting an interactive act at a viewer interactive point, presenting to the viewer at least one impressionized version of the source medium which is generated by combining, at least in part, the source medium and the at least one of the multiple advertisements or an ad-relevant content related to the at least one of the multiple advertisements.

18. The method as recited in claim 17, further comprising:
displaying the at least one of the multiple advertisements along with the at least one impressionized version of the source medium.

19. The method as recited in claim 17, wherein the impressionized version of the source medium includes a viewer interactive point through which the viewer interacts with the impressionized version of the source medium.

20. A computer readable medium having computer-executable instructions that, when executed, perform acts comprising:
computing an ad relevance between each of multiple advertisements and a source medium;
associating at least one of the multiple advertisements with the source medium based, at least in part, on the calculated ad relevance of the multiple advertisements; and
presenting to the viewer at least one impressionized version of the source medium which is adapted to cause a change of an impression to a viewer in response to an interactive act conducted by the viewer in relation to the impressionized version of the source medium.
